(19) United States
(12) Patent Application Publication
(10) Pub. No.: US 2011/0096984 A1
(43) Pub. Date: Apr. 28, 2011

(54) IMAGE PROCESSING DEVICE, METHOD FOR IMAGE PROCESSING, AND IMAGE FORMING APPARATUS

(75) Inventor: Toshiki Mamura, Osaka (JP)

(73) Assignee: KYOCERA MITA CORPORATION, Osaka (JP)

(21) Appl. No.: 12/899,223

(22) Filed: Oct. 6, 2010

(30) Foreign Application Priority Data
Oct. 28, 2009 (JP) 2009-247192

(51) Int. Cl. G06K 9/34; G06K 9/48

(52) U.S. Cl. 382/164; 382/199

(57) ABSTRACT

An image processing device includes a background specifying unit and a filled area specifying unit. The background specifying unit specifies the lightness of a background portion of a document image. The filled area specifying unit determines, on each pixel scattered in a predetermined pattern, among pixels constituting the document image, whether the lightness of the pixel lies in a predetermined range is different from the lightness of the background portion to specify a filled area based on the position of the pixel having the lightness lying in the predetermined range among the pixels scattered in the predetermined pattern.

### INCORPORATION BY REFERENCE

This application is based upon and claims the benefit of priority from the corresponding Japanese Patent application No. 2009-247192, filed Oct. 28, 2009, the entire content of which is incorporated herein by reference.

### BACKGROUND

The present invention relates to image processing devices, methods for image processing, and image forming apparatuses.

In some situations, when a document is scanned by a scanner, it is necessary to specify an area (hereinafter, referred to as a corrected area or filled area) filled with correction fluid.

Accordingly, there is a technique for calculating the color difference between each pixel and its adjacent pixel of the image of a scanned document, extracting areas having colors that are different from the color of a document sheet based on the color differences, detecting an area having the greatest grayscale level as a corrected area from among the areas, and processing image data so that the corrected area can be visually identified.

However, this technique has the disadvantage that it takes much time to detect a corrected area (filled area) because the image data is examined on a pixel-by-pixel basis.

### SUMMARY

According to an embodiment of the present disclosure, an image processing device is provided that includes a background specifying unit and a filled area specifying unit. The background specifying unit specifies the lightness of a background portion of a document image. The filled area specifying unit determines, on each pixel scattered in a predetermined pattern, among pixels constituting the document image, whether the lightness of the pixel lies in a predetermined range different from the lightness of the background portion to specify a filled area based on the position of the pixel lying in the predetermined range among the pixels scattered in the predetermined pattern.

According to another embodiment of the present disclosure, a method for image processing includes specifying a background and specifying a filled area. By specifying a background, the lightness of a background portion of a document image is specified. By specifying a filled area, a determination is made on each pixel scattered in a predetermined pattern among the pixels constituting the document image as to whether the lightness of the pixel that lies in a predetermined range is different from the lightness of the background portion, thereby specifying a filled area based on the position of the pixel lying in the predetermined range among the pixels scattered in the predetermined pattern.

According to another embodiment of the present disclosure, an image forming apparatus is provided that includes an image scanning unit, a background specifying unit, a filled area specifying unit, an image processing unit, and an image forming unit. The image scanning unit scans the image of a document. The background specifying unit specifies the lightness of a background portion of the document image. The filled area specifying unit determines, on each pixel scattered in a predetermined pattern among the pixels constituting the document image, whether the lightness of the pixel lies in a predetermined range that is different from the lightness of the background portion to specify a filled area based on the position of the pixel lying in the predetermined range among the pixels scattered in the predetermined pattern. The image processing unit performs predetermined image processing on the document image wherein the filled area is specified by the filled area specifying unit. The image forming unit forms the document image subjected to the image processing onto a predetermined recording medium.

Additional features and advantages are described herein, and will be apparent from the following Detailed Description and the figures.

### BRIEF DESCRIPTION OF THE FIGURES

The following detailed description, given by way of example, but not intended to limit the disclosure solely to the specific embodiments described, may best be understood in conjunction with the accompanying drawings, in which:

FIG. 1 is a block diagram illustrating the configuration of an image processing device according to an embodiment of the present disclosure;

FIG. 2 is a flowchart illustrating an operation of the image processing device illustrated in FIG. 1;

FIG. 3 is a diagram illustrating search for a corrected area by the image processing device of FIG. 1; and

FIG. 4 is a diagram illustrating a corrected area detected by the image processing device of FIG. 1.

### DETAILED DESCRIPTION

Reference will now be made to various embodiments of the disclosure, one or more examples of which are illustrated in the accompanying drawings. Each example is provided by way of explanation of the disclosure, and not meant to limit the present disclosure. In fact, it will be apparent to those skilled in the art that various modifications, combinations, additions, deletions and variations can be made in the present disclosure without departing from the scope or spirit of the present disclosure. For instance, features illustrated or described as part of one embodiment can be used in another embodiment to provide a still further embodiment. It is intended that the present disclosure covers such modifications, combinations, additions, deletions, applications and variations that come within the scope of the appended claims and their equivalents. Embodiments of image processing device, method for image processing, and image forming apparatus will now be described in detail.

An embodiment of the present disclosure will now be described below with reference to the drawings.

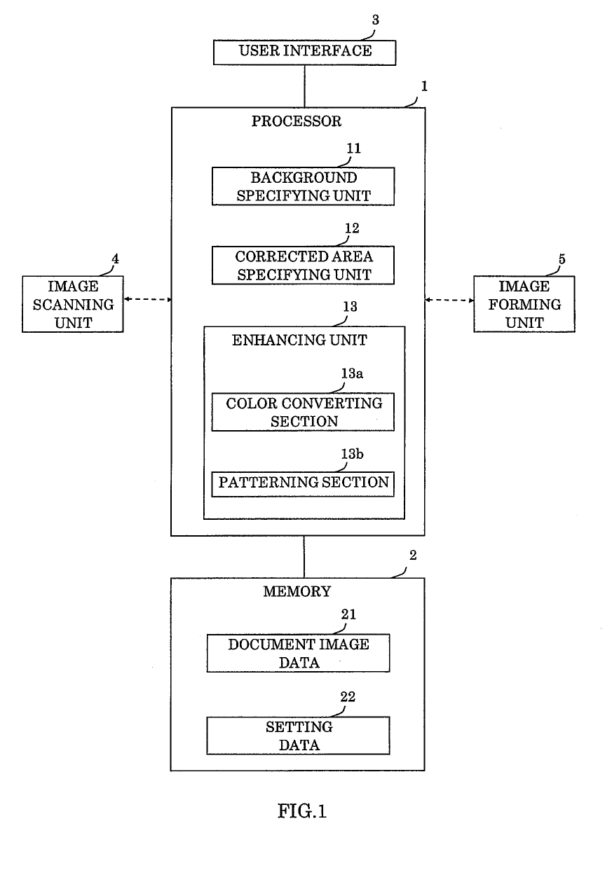

FIG. 1 is a block diagram illustrating the configuration of an image processing device according to an embodiment of the present disclosure.

The image processing device illustrated in FIG. 1 is included in an image forming apparatus such as a copier, a scanner, or a multifunction peripheral. The image processing device detects an area filled with correction fluid on a document as a corrected area (or filled area) in a document image based on, for example, the document image data scanned by a scanner function.

Referring to FIG. 1, the image processing device includes a processor 1, a memory 2, and a user interface 3. The memory 2 and the user interface 3 are connected to the processor 1. The image processing device is connected to an image scanning unit 4 and an image forming unit 5.

The processor 1 is a unit which comprises a computer including, for example, a central processing unit (CPU), a random access memory (RAM), and a read only memory (ROM) and which loads a predetermined program stored in a storage medium, such as the ROM or the memory 2, into the RAM and allows the CPU to implement the program, thus realizing various processing units. The processor 1 provides a background specifying unit 11, a corrected area specifying unit 12, and an enhancing unit 13.

The background specifying unit 11 specifies the lightness of a background portion of a document image based on document image data 21.

The corrected area specifying unit 12 determines, on each pixel scattered in a predetermined pattern among the pixels constituting the document image, whether the lightness of the pixel is greater than that of the background portion and specifies a corrected area based on the positions of the pixels having a lightness greater than that of the background portion among the pixels scattered in the predetermined pattern.

In this embodiment, the corrected area specifying unit 12 divides a document image into segments each having a predetermined number of pixels (a plurality of pixels) and determines, on a representative pixel at a predetermined position in each segment, whether the lightness of the representative pixel is greater than the lightness of a background portion, thereby specifying a segment including the representative pixel (at least one representative pixel when there are a plurality of representative pixels) having a lightness greater than that of the background portion as a corrected area. In this embodiment, the above-described segments each have a rectangular shape. Representative pixels are four pixels at the four corners of each segment.

Typically, a filled area filled with correction fluid on a document is sufficiently larger than a pixel. Accordingly, even the narrowest portion of the filled area may have a length of several to several tens of pixels. This embodiment focuses on the above-described characteristics of a filled area. According to this embodiment, pixels scattered in a predetermined pattern are detected, instead of detecting on a pixel-by-pixel basis.

The enhancing unit 13 performs image processing on a corrected area in order to indicate the presence of the corrected area specified by the corrected area specifying unit 12.

According to this embodiment, the enhancing unit 13 includes a color converting section 13a and a patterning section 13b. The color converting section 13a changes the color of a correction area specified by the corrected area specifying unit 12. The patterning section 13b superimposes a pattern indicating the presence of a corrected area on a document image when the corrected area specifying unit 12 specifies at least one corrected area on the document image.

The memory 2 stores various pieces of data. The memory 2 includes, for example, a semiconductor memory and a hard disk drive. The memory 2 stores the document image data 21 and setting data 22. The document image data 21 is image data obtained by scanning a document through the scanner function of the image scanning unit 4. The setting data 22 is data including settings as to whether to detect and enhance a corrected area, as will be described later.

The user interface 3 includes a display unit, such as a liquid crystal display, and an input unit including, for example, a touch panel and a key switch. The user interface 3 provides various pieces of information to a user and accepts user input.

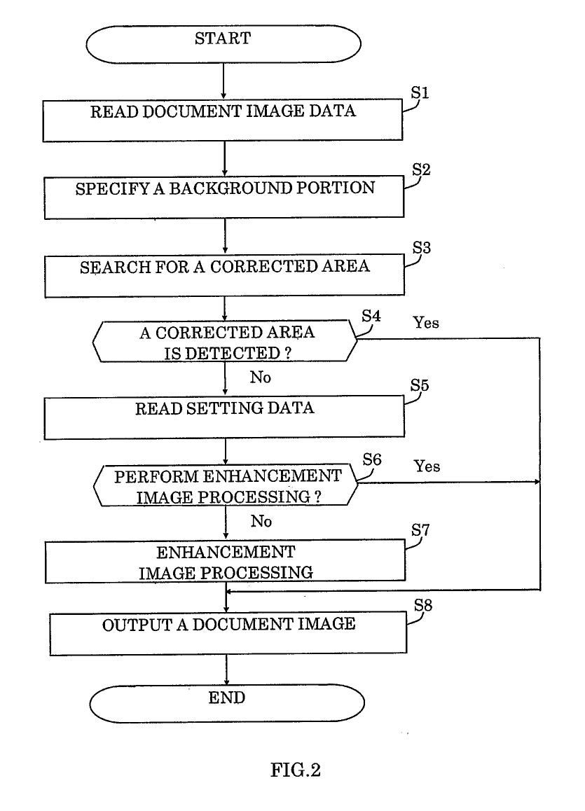

An operation of an embodiment of the above-described device will now be described. FIG. 2 is a flowchart explaining the operation of the image processing device illustrated in FIG. 1.

First, the background specifying unit 11 reads the document image data 21 (step S1) and specifies the lightness of a document sheet (i.e., the lightness of a background portion) in a document image (step S2). At this time, the background specifying unit 11 specifies the lightness of the background portion in an area without characters and images in the document image data 21.

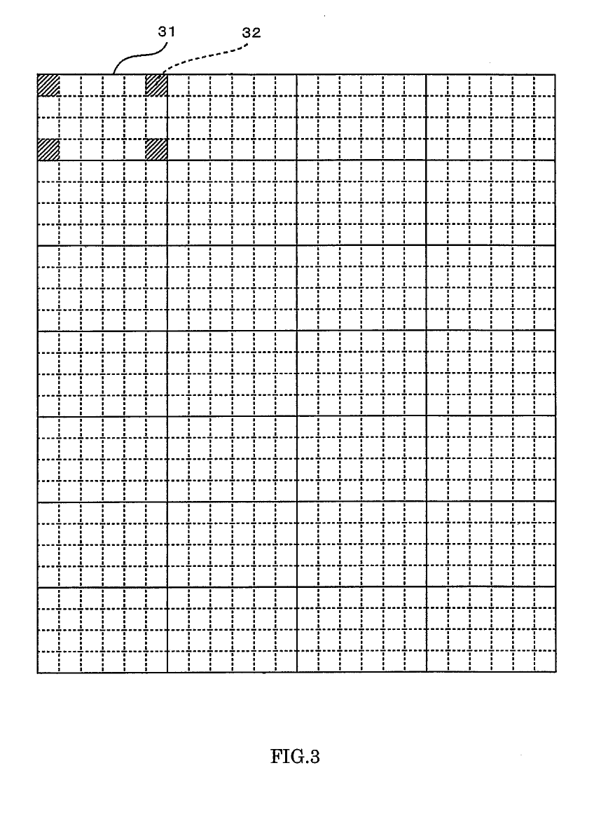

Next, the corrected area specifying unit 12 searches the document image data 21 for a corrected area (step S3). FIG. 3 is a diagram explaining the search for a corrected area by the image processing device illustrated in FIG. 1.

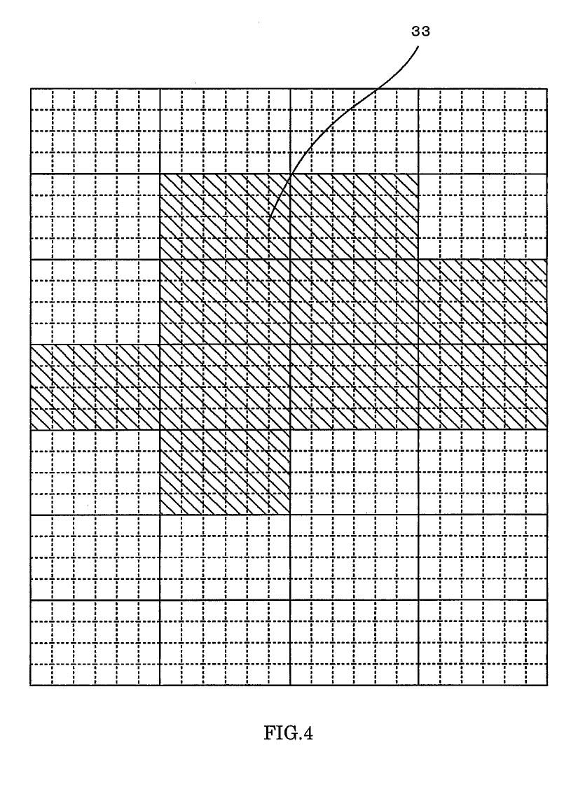

As illustrated in FIG. 3, the corrected area specifying unit 12 divides a document image (here, one including 28 pixels in the vertical (sub-scanning) direction by 24 pixels in the horizontal (main scanning) direction) into segments 31 each including a predetermined number of pixels in the vertical direction by those in the horizontal direction (here, including 4 pixels in the vertical direction by 6 pixels in the horizontal direction). The corrected area specifying unit 12 determines, on each of the representative pixels 32 at predetermined positions in each segment 31 (in this case, four pixels at the four corners of each segment 31), whether the lightness of the representative pixel 32 is greater than that of the background portion. In FIG. 3, the pixels are indicated by dashed lines and the segments 31 are indicated by solid lines. The corrected area specifying unit 12 specifies the segment 31 including at least one representative pixel 32 having a lightness greater than that of the background portion as a corrected area. FIG. 4 is a diagram illustrating a corrected area 33 detected by the image processing device illustrated in FIG. 1.

At the completion of the search for the corrected area 33 by the corrected area specifying unit 12, if at least one corrected area 33 is detected (Yes in step S4), the enhancing unit 13 first reads the setting data 22 (step S5) and determines whether to perform enhancement image processing (step S6).

In this embodiment, executable enhancement image processing includes: (1) color conversion for converting the color of the detected corrected area 33; and (2) patterning for indicating the detected corrected area 33. Accordingly, the setting data 22 previously includes setting information indicating whether to perform the color conversion as enhancement image processing and setting information indicating whether to perform the patterning as enhancement image processing. In this situation, enhancement image processing to be performed is specified based on the setting data 22. Alternatively, enhancement image processing to be performed may be specified using the user interface 3.

When determining that enhancement image processing is to be performed (Yes in step S6), the enhancing unit 13 performs enhancement image processing designated by the setting data 22 on the document image data 21 (step S7). To perform the color conversion, the enhancing unit 13 converts the color (or pixel value) of a portion having a lightness greater than that of the background portion in the detected corrected area 33 into an emphasized color (e.g., red) that can be easily visually identified. Note that the enhancing unit 13 determines a portion having a lightness less than that of the background portion in the detected corrected area 33 as a character in the corrected area 33 and sets the above-described emphasized color to a color other than that of the character and does not change the color of the character in the corrected area 33.

If no corrected area 33 is detected during the search for the corrected area 33 (No in step S4), the enhancing unit 13 does not perform the above-described enhancement image processing. In addition, when it is determined that no enhancement image processing is to be performed (No in step S6), the enhancing unit 13 does not perform the above-described enhancement image processing.

After that, a document image is outputted based on the document image data 21 (step S8). At that time, for example, the document image is displayed by the display unit (not illustrated) or is printed by the image forming unit 5. When the corrected area 33 is detected and is subjected to enhancement image processing before being outputted, a document image based on the document image data 21 subjected to enhancement image processing is outputted.

As described above, according to this embodiment, the background specifying unit 11 specifies the lightness of the background portion of the document image based on the document image data 21, the corrected area specifying unit 12 determines, on each of the pixels scattered in the predetermined pattern among pixels constituting the document image, whether the lightness of the pixel is greater than that of the background portion and specifies the corrected area based on the positions of the pixels having a lightness greater than that of the background portion among the pixels scattered in the predetermined pattern.

Consequently, since the corrected area is specified using only some of the pixels scattered in the document image, the corrected area in the document image can be detected in a short time period.

According to the above-described embodiment, the corrected area 33 filled with correction fluid has been explained as a filled area. The filled area is not limited to the corrected area 33, but, may include an area filled with another filling medium, such as marker fluid.

In the above-described embodiment, the corrected area specifying unit 12 for specifying the corrected area 33 based on the positions of the pixels having a lightness greater than that of the background portion among the pixels scattered in the predetermined pattern, has been explained as a filled area specifying unit. The filled area specifying unit is not limited to the corrected area specifying unit 12. Any unit may be used so long as the unit specifies a filled area based on the positions of pixels having a lightness lying in a predetermined range that is different than the lightness of the background portion among the pixels scattered in the predetermined pattern.

According to the above-described embodiment, the corrected area specifying unit 12 divides a document image into segments and determines, on a representative pixel at a predetermined position in each segment, whether the lightness of the representative pixel is greater than that of a background portion, thus specifying the segment including the representative pixel having a lightness greater than that of the background portion as a corrected area.

Consequently, the representative pixels can be examined using simple calculation in a short time period because the representative pixels are regularly arranged. Thus, a corrected area in a document image can be detected in a shorter time period.

The above-described embodiment is a preferred embodiment of the present disclosure. The present disclosure is not limited to the embodiment, but, many modifications and variations may be made without departing from the spirit and scope of the present disclosure.

For example, the pattern of pixels to be examined for lightness corresponds to the arrangement of the pixels at the four corners in segments included in a document image in the above-described embodiment. However, another pattern may be used.

In the above-described embodiment, the representative pixels are four pixels at the four corners of each segment. A single pixel, two pixels, or three pixels at predetermined positions of the four pixels may be used.

In the above-described embodiment, each segment is an area of 4 pixels in the vertical direction by 6 pixels in the horizontal direction. However, a different number of pixels in the vertical direction and/or that in the horizontal direction of the segment may be used (preferably, three pixels or more in each of the vertical and horizontal directions).

In the above-described embodiment, when the corrected area 33 is detected, the enhancing unit 13 performs enhancement image processing. However, the processing is not limited to enhancement image processing. Another image processing may be performed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image processing device comprising:
a background specifying unit that specifies a lightness of a background portion of a document image; and
a filled area specifying unit that determines, on each pixel scattered in a predetermined pattern among pixels constituting the document image, whether a lightness of the pixel lies in a predetermined range that is different from the lightness of the background portion to specify a filled area based on a position of the pixel having a lightness lying in the predetermined range among pixels scattered in the predetermined pattern.

2. The device according to claim 1, wherein the filled area specifying unit divides the document image into segments each having a predetermined number of pixels and determines, on a representative pixel at a predetermined position in each segment, whether a lightness of the representative pixel lies in the predetermined range to specify a segment including the representative pixel having the lightness lying in the predetermined range as a filled area.

3. The device according to claim 2, wherein
each segment has a rectangular shape; and
the representative pixel is at least one of four pixels at the four corners of the segment.

4. The device according to claim 1, wherein:
the filled area is a corrected area; and
the predetermined range corresponds to a lightness greater than the lightness of the background portion.

5. The device according to claim 4, comprising:
an enhancing unit that performs image processing for enhancing the corrected area on the document image.

6. The device according to claim 5, wherein the enhancing unit includes a color converting section that changes a color of the corrected area specified by the filled area specifying unit.

7. The device according to claim 6, wherein the color converting section changes the color of pixels having a lightness greater than that of the background portion in the corrected area.

8. The device according to claim 7, wherein the color converting section changes the color of pixels having the lightness greater than that of the background portion in the corrected area to a color that is different from the color of pixels having a lightness that is less than that of the background portion in the corrected area.

9. The device according to claim 5, wherein the enhancing unit includes a patterning section that, when the filled area specifying unit specifies at least one corrected area, performs a patterning to superimpose a pattern indicating the presence of the corrected area on the document image.

10. A method for image processing, comprising:
specifying a lightness of a background portion of a document image; and
determining, on each pixel scattered in a predetermined pattern, among pixels constituting the document image, whether a lightness of the pixel lies in a predetermined range that is different from the lightness of the background portion to specify a filled area based on a position of the pixel having a lightness lying in the predetermined range among pixels scattered in the predetermined pattern.

11. The method according to claim 10, wherein:
the document image is divided into segments each having a predetermined number of pixels; and
a determination is made on a representative pixel at a predetermined position in each segment as to whether a lightness of the representative pixel lies in the predetermined range to specify a segment including the representative pixel having the lightness lying in the predetermined range as a filled area.

12. An image forming apparatus comprising:
an image scanning unit that scans the document image;
a background specifying unit that specifies a lightness of a background portion of the document image;
a filled area specifying unit that determines, on each pixel scattered in a predetermined pattern among pixels constituting the document image, whether a lightness of the pixel lies in a predetermined range that is different from the lightness of the background portion to specify a filled area based on a position of the pixel having a lightness lying in the predetermined range among pixels scattered in the predetermined pattern;
an image processing unit that performs predetermined image processing on the document image in which the filled area is specified by the filled area specifying unit; and
an image forming unit that forms the document image, subjected to the image processing, onto a predetermined recording medium.

13. The apparatus according to claim 12, wherein the filled area specifying unit divides the document image into segments each having a predetermined number of pixels and determines, on a representative pixel at a predetermined position in each segment, whether a lightness of the representative pixel lies in the predetermined range to specify a segment including the representative pixel having a lightness lying in the predetermined range as a filled area.
